(19) United States
(12) Patent Application Publication
(10) Pub. No.: US 2006/0161505 A1
(43) Pub. Date: Jul. 20, 2006

(54) System and method for processing multiple mailings

(75) Inventors: Juergen Sattler, Wiesloch (DE); Joachim Gaffga, Wiesloch (DE)

Correspondence Address: KENYON & KENYON LLP, 1500 K STREET N.W., SUITE 700, WASHINGTON, DC, 20005, US

(73) Assignee: SAP Aktiengesellschaft

(21) Appl. No.: 11/035,068

(22) Filed: Jan. 14, 2005

(51) Int. Cl. B65B 35/00; G06F 17/00; G07B 17/02

(52) U.S. Cl. 705/406; 705/408

(57) ABSTRACT

A system and method for processing multiple mailings is provided. In some embodiments, electronic orders are received from mail originators, with each received order specifying the physical delivery of mail-pieces to destinations. A subset of each of the plurality of orders may be combined into a combined electronic order, and the combined electronic order may be transmitted to a mail-service provider for printing and mailing of the specified mail-pieces to the specified destinations.

### BACKGROUND

Organizations may send quantities of physical mail to their clients or potential clients (hereinafter “mail-recipients”), such as so-called mass mail, bulk mail, etc. These pluralities of physical mailings may extend into the tens or thousands of individually addressed mail-pieces. As used herein, a “mail-piece” is a single unit of mail, such as for example an envelope containing correspondence, a flyer, a postcard, a package, or the like. In recent years, it has become possible to supplement or even replace the delivery of physical mail-pieces with e-mail. There continues, however, to be a need for physical delivery of hard copies of mail-pieces to mail-recipients via a mail delivery network, such as the United States Post Office, United Parcel Service, any overnight carrier, or the like (hereinafter collectively referred to as the “mail network”).

Certain entities provide mail services such as printing, stuffing (if needed), and/or addressing quantities of mail-pieces for subsequent processing through the mail network. These certain entities are referred to herein as “mail-service providers.” An example of a mail service provider is Deutsche Post PrintCom Service, which may provide for handling of business mail an entity.

As the greatest profit for mail-service providers is achieved by processing the largest volumes of mail, mail-service providers will typically set price-breaks that may reduce the cost per mail-piece as the number of mail-pieces increases. Moreover, certain mail-service providers are disinclined to process small quantities of mail-pieces and have set minimum quantity requirements on orders. The term “small quantities” is relative and must be determined on a case-by-case basis. Many mail originators, therefore, may not be able to receive the advantageous pricing set for the largest orders and/or may not be able to use the services of certain mail-service providers because the mail-service providers' minimum quantity requirements will not be met.

Known systems and methods do not provide mail originators, such as religious or community service organizations, schools, or businesses, for example, with an opportunity to receive a per mail-piece pricing level that is usually available to mail originators serving comparatively larger numbers of mail-recipients. Nor do known systems and methods alleviate the problems of meeting mail-service providers' minimum quantity requirements. Another need may be to provide mail originators with archival storage of their mail content and/or mailing lists. Accordingly, the present inventors perceive these and other needs in the art.

### BRIEF DESCRIPTION OF THE DRAWINGS

FIGS. 1-2 illustrates a high-level block diagram of a system in accordance with embodiments of the invention.

FIG. 3 is a block diagram of a mail originator's system in accordance with an embodiment of the invention.

FIG. 4 is a flow diagram of a method in accordance with an embodiment of the invention.

### DETAILED DESCRIPTION

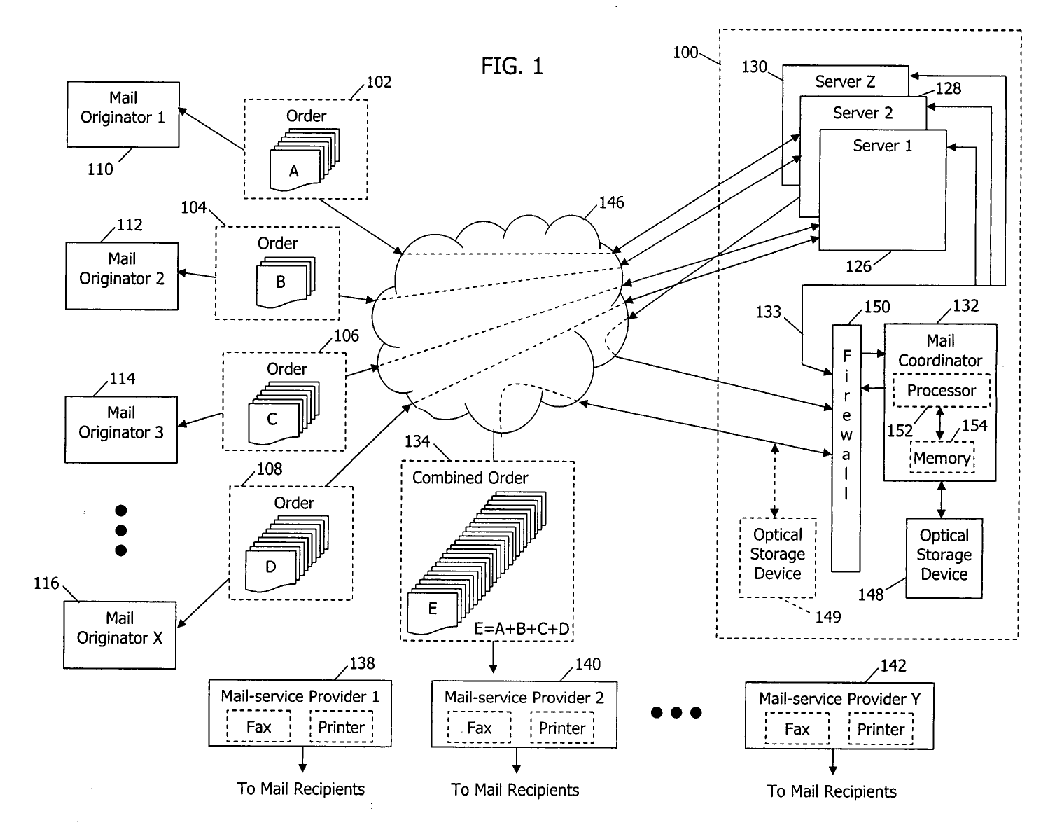

In accordance with some embodiments of the invention, a system and method is disclosed to help satisfy the needs of originators of a relatively small quantity of multiple mailings. FIG. 1 illustrates a high-level block diagram of a system in accordance with an embodiment of the invention. In accordance with some embodiments, a mail aggregation system 100 may receive a plurality of orders 102, 104, 106, 108 from a plurality of mail originators 110, 112, 114, 116, may combine these orders to form a combined order 134, and may send the combined order to one of mail providers 138, 140 or 142. Each order 102, 104, 106, 108 specifies (represents) the physical delivery of mail-pieces to a plurality of destinations. A mail originator may be a business or other entity that originates an order for mailings by sending that order from its computer system to the mail aggregation system 100. Mail providers 138, 140 or 142 may be entities that provide mail services such as printing, stuffing (if needed), and/or addressing quantities of mail-pieces for subsequent processing through the mail network, depositing of the mail-pieces into the mail network, and/or delivery of mail-pieces to specified recipients.

In the example of FIG. 1, orders 102, 104, 106, and 108 represent orders for quantities A, B, C, and D of mail-pieces to be delivered, respectively. The quantity of mail-pieces, A, B, C, and D, in each order need not be equal. Each mail-piece may eventually be delivered to one of a plurality of mail-recipients (not shown). The orders 102, 104, 106, 108 may be received by any of a plurality of servers 126, 128, 130. In an alternate embodiment, a central server (not shown) may receive all orders 102, 104, 106, 108. The mail aggregation system 100 may receive data including, but not limited to, files comprising metadata, text content, and graphic content, as well as files comprising address lists, in any number of ways. For example, data may be received as attachments to e-mail, another type of electronic transmission, on magnetic or optical storage media, etc.

FIG. 1 illustrates some possible paths of data to and from the mail aggregation system 100. Mail originators 110, 112, 114, 116 may be coupled to one or more servers 126, 128, 130 via a communications network 146, such as the Internet. One or more servers 126, 128, 130 may also be coupled to the mail coordinator 132 via hardwire connection(s) 133 and/or via a communications network 146. Mail coordinator 132 may be coupled to one or more mail-service providers 138, 140, 142 via the communications network 146.

From time to time, a mail coordinator 132 may combine the plurality of orders 102, 104, 106, 108, or subsets thereof, stored within one or more of the plurality of servers 126, 128, 130. The plurality of servers 126, 128, 130 may be coupled to the mail coordinator 132 via a firewall 150. The firewall 150 may be implemented in software within a computer system running the mail coordinator 132 or in a stand-alone piece of hardware. The firewall 150 may protect the mail coordinator 132 from an attack from the outside that may arrive via an interface between it and one or more of the servers 126, 128, 130 or via a coupling to a communications network 146, such as the Internet.

As illustrated in FIG. 1, the data communication paths may be bi-directional. For example, upon receipt of an order from a mail originator 110, 112, 114, 116, the mail aggregation system 100 may transmit to the mail originator an acknowledgement of the order and/or further information, such as estimated time of delivery, estimated or actual cost, identity of mail-service provider(s) used to fill the order, order status, etc. By way of further example, a mail-service provider 138, 140, 142 may transmit to the mail aggregation system 100 a bid for the cost of a potential order, an acknowledgement, and/or further information such as, but not limited to, that described above with reference to a mail originator and mail aggregation system 100.

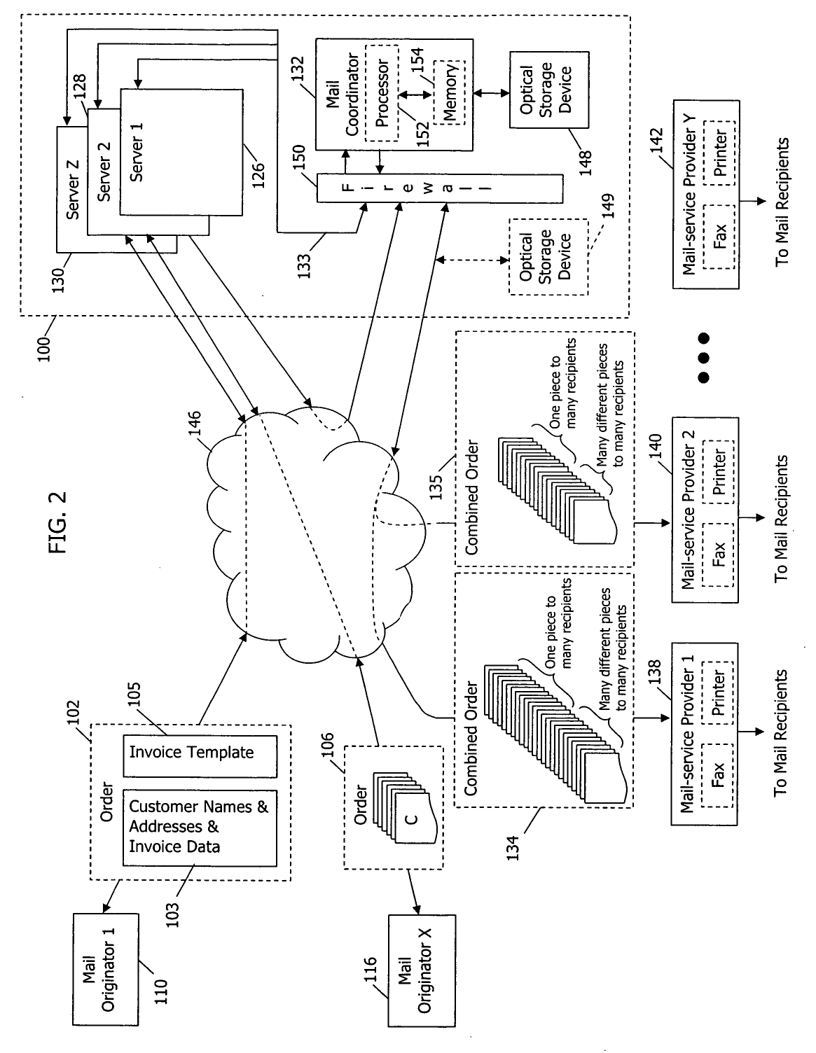

The mail coordinator 132 may combine orders into at least one combined order 134. Accordingly, a combination of orders 102, 104, 106, 108, or subsets thereof, may be combined to create one or more combined orders. For example, orders 102, 104, 106, 108 may contain mail-pieces directed to mail recipients in a particular region or country (e.g., Germany or the western region of the United States). Thus, in a combined order the mail coordinator 132 may generate a first combined mail order 134 which contains a first subset of mail-pieces bound for mail-recipients in California, while substantially simultaneously generating a second combined mail order (shown as 135 in FIG. 2) with a second subset of mail-pieces bound for mail-recipients in Germany. The first combined mail order 134 may include some mail-pieces from order 102, some from order 104, some from order 106, and/or some mail-pieces from order 108 which have recipients in the region (e.g., California) that is covered by first combined mail order 134. Similarly, the second combined mail order may include some mail-pieces from order 102, some from order 104, some from order 106, and/or some mail-pieces from order 108 which have recipients in another region (e.g., Germany) that is covered by the second combined mail order. The mail coordinator 132 may then transmit the first combined order to a mail-service provider in California, while substantially simultaneously transmitting a second combined mail order to a mail-service provider in Germany. Mail-service providers world-wide may be similar to mail-service providers 138, 140, 142.

FIG. 2 illustrates a use of some embodiments of the invention wherein a mail originator 110 may place an order 102, which may be comprised of, for example, data 103 and a template 105. The data 103 may represent, for example, customer names, addresses corresponding to the customer names, and values to be populated into at least one invoice per customer. The template 105, such as a template for an invoice, may be included in the order 102. In this example the order 102 includes sufficient information (e.g., data 103 and template 105) such that many individualized mail-pieces may be created and sent to many mail-recipients (e.g., customers). Individualized templates may be populated by, for example, a server 128, a mail coordinator 132, or a mail service provider 138, 140, 142. As illustrated, the combined order(s) 134, 135 may be comprised of many different mail-pieces to be delivered to many different mail-recipients and/or a single document to be delivered to different mail-recipients. Other combinations are possible. The mail-recipients may be in different geographic localities or regions. Each region may be serviced by at least one mail-service provider 138, 140, 142. As like reference numbers in FIGS. 1 and 2 identify like components, the description of these components thus will not be repeated.

In the illustrative embodiments of FIGS. 1 and 2, each combined order 134 specifies a plurality of mail-pieces. In some embodiments the plurality of mail-pieces may be the sum of the quantities of mail-pieces in the component orders 102, 104, 106, 108, or subsets thereof. For example, mail-piece plurality “E” in combined order 134 is equal to the sum of quantities of mail-pieces A, B, C, and D transmitted to mail aggregation system 100 by mail originators 110, 112, 114, and 116, respectively. In some embodiments, the plurality of mail-pieces may be derived by summing the number of addressees receiving mail-pieces from all mail originators in a combined order. In some embodiments, the plurality of mail-pieces may be a combination of the quantities expressed in the preceding two examples. Of course, other combinations are possible.

While individual orders 102, 104, 106, 108 may not meet or exceed a mail-service provider's minimum order plurality, the combined order 134 can be generated to at least meet the mail-service provider's minimum order plurality. Moreover, it may be possible to combine a plurality of orders, or subsets thereof, from one or more mail originators, such that a favorable price per mail-piece can be negotiated or obtained for the mail originator(s) 110, 112, 114, 116. Another advantage, as described herein below, may be that a single order to multiple geographic regions can be divided into multiple sub-orders. Each of the sub-orders may go to a mail-service provider that is geographically proximate to (e.g., within or nearby) the region within which the recipients of the sub-order are located. As used herein, geographically proximate may be measured in terms that vary from an area corresponding to a United States ZIP code up to areas in excess of the size of a country. As used herein, the term “region” may comprise portions of countries or combinations of countries. This sub-division for localization of the mail-service provider(s) may be advantageous in reducing the time between mailing of a mail-piece and the mail-piece's receipt by its intended recipient.

In some embodiments, the mail coordinator 132 may transmit the combined order 134 to one of the plurality of mail-service providers 138, 140, 142, in accordance with instructions provided by, or predefined agreements with, the mail originator. In some embodiments, the mail coordinator 132 may select which of the plurality of mail-service providers 138, 140, 142 will receive the combined order 134. As noted both hereinabove and hereinafter, a combined order may be comprised of one or more subsets of one or more original orders. Thus, an original order may be combined with other orders in its entirety or may be divided into subsets, with each subset going to one or more mail-service providers. A predefined list of mail-service providers may be stored in a memory 154 of the mail coordinator 132. Memory 154 may be any medium capable of storing instructions and of being read by a machine such as a compact disk, hard drive memory, floppy disk memory, DVD-ROM, CD-ROM or any type of machine-readable (computer-readable) storing medium. The set of instructions may be included within a computer program (which as is well known comprises a plurality of instructions) that is executable by a computer system. The list may include, for example, the regions served by the mail-service providers, their geographic location, and rates charged for various services.

Mail aggregation system 100 may receive orders from one or more mail originators 110, 112, 114, 116. The mail originators 110, 112, 114, 116 may not have knowledge of the identities of other mail originators 110, 112, 114, 116 with whom their own order, or subset thereof, will be combined. However, in some embodiments, an indication of the identities of some or all of the mail originators 110, 112, 114, 116 in a combined order 134, may be observed by one or more other mail originators.

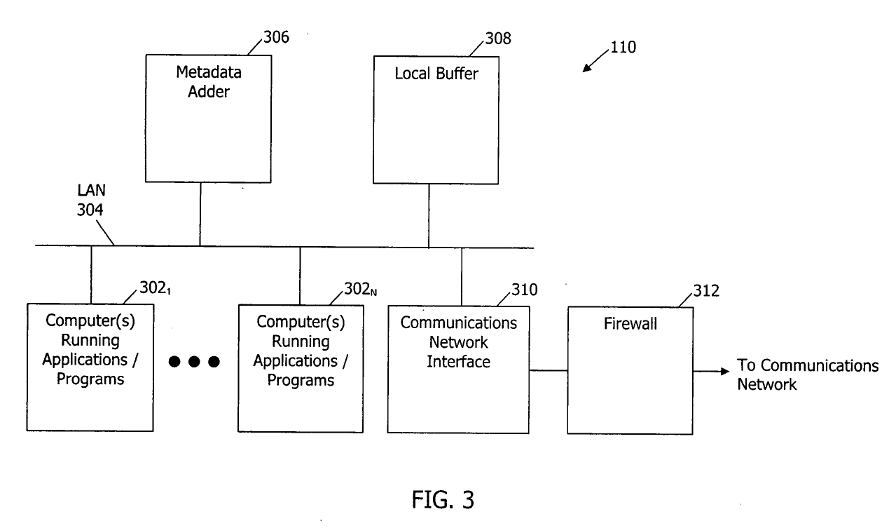

FIG. 3 is a block diagram of an exemplary mail originator's system 110 in accordance with an embodiment of the invention. A mail originator 110 may have a requirement to send mail-pieces to mail-recipients. The mail originator may use applications or programs running on computer(s) 302 on its own local area network (LAN) 304 to create text and graphic content for a mail-piece. In some embodiments, the mail originator may wish to electronically transmit the data comprising the mail-piece, or data that allows for the generation of multiple different mail-pieces, to a system 100 for combination with other orders and transmission to mail-service providers 138, 140, 142 as previously described.

In some embodiments, as part of a transmission process, metadata may be added to the data sent to mail aggregation system 100. Metadata may be added, for example, by an application running on one or more of the computers 302 coupled to the LAN 304. Metadata may be added, for example, by a metadata adder 306 that may be embodied in one or more of the computers 302 coupled to the LAN 304. Metadata may include, for example, identification of the mail originator, the number of mail-pieces in an order, a source, location, and/or filename(s) of address files comprising lists of addresses of mail-recipients to be applied to the mail-pieces. In general, such metadata may be useful for sending a communication from one location to another location via an intermediary, such as server 126, without a need to “look into” the communication to obtain the recipient's address.

In some embodiments, a local buffer 308 may provide a location for intermediate storage of all data comprising an order 102, 104, 106, 108. The local buffer 308 may provide a capability of repeating a transmission of an order. The local buffer 308 may provide a capability to delete designated files and re-start an order transmission to a mail aggregation system 100. In some embodiments, the local buffer 308 may be provided by space, e.g., hard disc space, on one or more of the computers 302 that may be coupled to the LAN 304. In another embodiment, the local buffer 308 may be a piece of hardware coupled to the LAN 304.

Orders may be directed from the local buffer 308 to one or more servers 126, 128, 130 of a mail aggregation system 100 via a communication network 146 such as the Internet. The local buffer 308 itself may be coupled to a communications network interface device 310 coupled to the LAN 304. The network interface device 310 may be a stand-alone device or it may be integrated into one or more computers 302 on the LAN 304. The communications network interface device 310 may include a firewall 312. Alternatively, the firewall 312 may be resident in a stand-alone device. As known to those of skill in the art, a firewall may limit the exposure of all devices it is coupled with to attack from outside.

In one embodiment, an order may be, for example, an electronic transmission of, for example, instructions to print copies of a first letter that is stored as an attached file. In another embodiment, a order may be, for example, an electronic transmission of, for example, instructions to print copies of a first letter that is stored as an attached file, stuff the copies into envelopes, put the addresses found in a second attached file onto the envelopes, place postage on the envelopes, and send all envelopes to a post office for mailing. In one instance, an order may be, for example, an electronic transmission of a predefined instruction that provides a pointer to a file comprising a master document and another pointer to a file comprising a list of addresses or other information to be merged into individualized copies of the master document.

In the back-end, the mail coordinator 132 may transmit a combined order 134 to a mail-service provider, such as mail-service provider 138, 140, 142. The transmission may be routed through a communications network 146, such as the Internet.

The mail coordinator 132 may also ensure that international deliveries of mail are sent to certain international mail-service providers based on, for example, promises of performance set out in predefined contracts (a.k.a., service level agreements). A service level agreement may set forth, among other things, a maximum delivery time (that is, the time between the mailing and receipt of a mail-piece). For example, a mail-service provider may agree to deliver mail within one day of its receipt of a mail delivery order for one price, and agree to deliver mail within one week for a different price.

The mail coordinator 132 may also ensure that international deliveries of mail are sent to international mail-service providers based on a degree to which the mail-service provider is geographically proximate to the mail recipients. For example, if a mail originator was in the United States but one or more mail-recipients were in Germany, then a mail-service provider may be chosen that is local to Germany. This choice, for example, may reduce overall costs to the mail originator. Moreover, mail-service providers that are geographically local to mail-recipients may be selected to reduce the delivery time of the mail-pieces. In one example, a mail originator in Germany, desiring to send invoices to mail recipients in the Eastern and Western regions of the United States, could result in the selection of mail-service providers in New York and Los Angeles, respectively. The time between mailing and receipt of an invoice (i.e., delivery time) will be less for local mailings than for international mailings. Also, note that the above example encompasses an acceptable process whereby an order from one mail originator may be divided and sent to two or more mail mail-service providers.

The mail coordinator 132, in accordance with an embodiment of a system, may allow a mail-service provider, such as mail-service provider 140, to act as a print service dealer. A mail-service provider may send many different pieces of mail to many different recipients. For example, the mail-service provider may send any number of individual invoices, each having content different from the next, to any number of recipients. While one piece of mail (e.g., an invoice) may go to only one recipient, nothing herein restricts the use of sending several different pieces of mail (e.g., several unique invoices) to one recipient. Additionally, a mail-service provider may, for example, merge a master document with addresses from an address list file and print the mail-pieces (for transmission through the mail system). In acting as a print service dealer, the mail coordinator 132 may obtain good rates based on a combination of a plurality of orders and/or subsets thereof.

In some embodiments, the printed results may be archived, for example, by the mail coordinator 132. Archival storage may be accomplished in any number of formats, such as GIF or TIF. In some embodiments, archives may be stored on optical media, for example, in optical storage device 148. It is noted that in some embodiments archival records may be made available to users, such as mail originators. Those of skill in the art will understand how to accommodate user access to archival storage devices, such as optical storage device 148. In some embodiments, the printed results can be returned to the mail originator for further processing.

In some embodiments, orders 102, 104, 106, 108 may be provided in one or more formats, such as Extensible Markup Language (XML), Portable Document Format (PDF), or other document formats. In other words, there may be no need to have pre-printed paper on the mail-service provider's side. This feature may reduce a mail-service provider's storage costs associated with specialty paper.

In some embodiments, mail originators can customize their own systems to select which form and/or format of data the mail originator wishes to send or receive. Likewise, a mail-service provider may also be able to customize its own systems to select which form and/or format of data it wishes to send or receive. For example, one entity may select to send and receive data via an e-mail program with attachments while another entity may select to send or receive data via a short message service (SMS) enabled system. A third entity may wish to send or receive data via facsimile. Of course, the form and/or format of data to be received may be different from the form and/or format of data to be transmitted. This may be true for any mail originator or mail-service provider. The ability of a mail originator or mail-service provider to customize a system in the manner disclosed is a further benefit of the invention. In embodiments, such customizing is transmitted to aggregator system 100, for example over an Internet transmission. For example, a mail mail-service provider may transmit mailings to recipients via Internet transmission of Adobe® PDF (Portable Document Format) files, while the mail coordinator 132 may transmit notifications and confirmations of certain things, such as occurrence of predefined events or the reaching of milestones, to the mail originator. As another example, a party that is to receive a document (e.g., an invoice) may customize they way the are to receive the document, such as by selecting receipt by standard mail, by facsimile, by email with an attached .pdf file, not to receive any more such documents, etc. The aggregator system 100 may maintain an Internet portal where all relevant communications regarding customizing may be directed. A recipient, which may not be a direct customer of the mail aggregator 100, may be directed to this portal as an enclose to a standard mailing or at the Internet site of a mail originator. A rule engine may be used to define how document transmissions are made. There may be a default way of transmitting, and entities (mail originators and mail receivers) may be able to overrule this default with their own preferences.

In some embodiments, the aggregator system 100 may provide electronic mailboxes to give mail originators access to archived (not printed) documents.

A further benefit of a use of a system and method in accordance with the invention is an ability to track a status of an order and to obtain information concerning an order's delivery date and time.

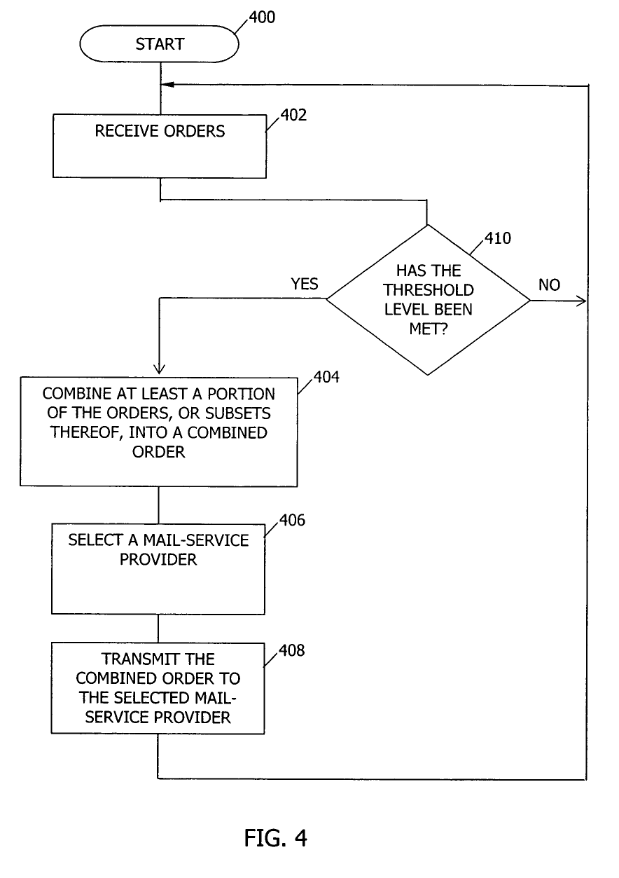

FIG. 4 is a flow diagram of a method in accordance with an embodiment of the invention. The method may begin at 400. At 402, a mail coordinator 132 may receive one or more orders from servers in a mail aggregation system 100. At 410, a determination may be made as to whether quantity of individual mail-pieces in the received orders has met a predefined threshold level. The threshold level may be determined, for example, by calculating the number of mail-pieces that could be sent to a mail-service provider(s) based on the then available orders. The calculated number could then be compared to a predetermined common threshold level for all mail-service providers, or compared to predetermined unique threshold levels for each of the plurality of mail-service providers. Other methods of determining if a threshold level has been met are also acceptable and within the scope of the embodiment of the invention. If the threshold level is not met, at least one more order should be received and the method may thus return to 402. If the threshold level is met, the method may continue to 404. At 404, the mail coordinator 132 may combine at least a subset of each of the plurality of orders into an aggregate or combined order. At 406, the mail coordinator 132 may select a mail-service provider for transmission to that mail-service provider of the aggregate or combined order. The mail-service provider may be selected from a predefined list of mail-service providers. The mail-service provider selection may be based on, for example, a minimum order quantity as set by the mail-service provider, a per mail-piece price provided by the mail-service provider, a price in a pre-negotiated contract with the mail-service provider, a published price as set by the mail-service provider, or instructions from the mail originator. In some embodiments, the mail originator may have requested express processing of its mail request and may have specified delivery of the mail items within a certain time frame (e.g., next day delivery, delivery within a week, etc.), in which case the mail-service provider may be selected based upon the mail-service provider's ability to provide the express processing that was requested. At 408, the mail coordinator 132 may transmit the aggregate or combined order to the selected mail-service provider(s). In some embodiments, a bill may be received by the mail aggregator from the mail-service provider for printing and mailing of the specified mail-pieces to the specified destinations. In a separate transaction, a mail aggregator may send a bill to each of the plurality of mail originators, and this bill may reflects the bill for the mailing of each mail-piece that was mailed and was specified in the order received from that mail originator.

The combining process may continue periodically or aperiodically. Successive receptions of a plurality of orders may be triggered by, for example, a predefined timetable or a polling of servers to determine if a sufficient quantity of orders have been received to justify their combination into an aggregate or combined order.

The above is a detailed discussion of the certain embodiments. It may be understood that the examples discussed are for illustration purposes only and are not intended to limit the configuration to that shown. It is of course intended that the scope of the claims may cover other embodiments than those described above and their equivalents.

What is claimed is:

1. A method, comprising:
receiving from a plurality of mail originators a plurality of electronic orders each specifying the physical delivery of mail-pieces to a plurality of destinations;
combining at least a subset of each of the plurality of orders into a combined electronic order; and
transmitting the combined electronic order to a mail-service provider for printing and mailing of the specified mail-pieces to the specified destinations.

2. The method of claim 1, wherein each electronic order represents a quantity of mail-pieces to be delivered, and wherein the combined electronic order represents a quantity of mail-pieces equal to or less than the sum of the quantities of mail-pieces in each of the received plurality of electronic orders.

3. The method of claim 2, wherein the quantity of mail-pieces represented by the combined electronic order is equal to or greater than a minimum order quantity of the mail-service provider.

4. The method of claim 1, wherein the combined order comprises a subset of the mail pieces in the received orders that are to be delivered to a particular region, and wherein the mail-service provider to which the combined order is transmitted is selected based upon the mail-service provider's proximity to that region.

5. The method of claim 1, wherein the method further comprises:
selecting the mail-service provider from a predefined list of mail-service providers before said transmitting the combined electronic order to a mail-service provided.

6. The method of claim 5, wherein the mail-service provider selection is based on a minimum order quantity as set by the mail-service provider.

7. The method of claim 5, wherein the mail-service provider selection is based on a per mail-piece price provided by the mail-service provider, a price in a pre-negotiated contract with the mail-service provider, or a published price as set by the mail-service provider.

8. The method of claim 1, wherein the method further comprises:
receiving a bill from the mail-service provider for printing and mailing of the specified mail-pieces to the specified destinations; and
sending a bill to each of the plurality of mail originators that reflects the bill for the mailing of each mail-piece that was mailed and was specified in the order received from that mail originator.

9. The method of claim 1, wherein the method further comprises:
archiving the mail-pieces that were transmitted to the mail-service provider;
receiving a request from a mail originator for mail-pieces that were to be mailed based on an order from that mail originator; and
transmitting the requesting mail-pieces from the archives to the requesting mail originator.

10. A machine-readable medium storing a set of instructions, the set of instructions capable of being executed by a processor to implement a method comprising:
receiving from a plurality of mail originators a plurality of electronic orders each specifying the physical delivery of mail-pieces to a plurality of destinations;
combining at least a subset of each of the plurality of orders into a combined electronic order; and
transmitting the combined electronic order to a mail-service provider for printing and mailing of the specified mail-pieces to the specified destinations.

11. The machine-readable of claim 8, wherein each electronic order represents a quantity of mail-pieces to be delivered, and wherein the combined electronic order represents a quantity of mail-pieces equal to or less than the sum of the quantities of mail-pieces in each of the received plurality of electronic orders.

12. The machine-readable of claim 9, wherein the quantity of mail-pieces represented by the combined electronic order is equal to or greater than a minimum order quantity of the mail-service provider.

13. The machine-readable of claim 8, wherein the combined order comprises a subset of the mail pieces in the received orders that are to be delivered to a particular region, and wherein the mail-service provider to which the combined order is transmitted is selected based upon the mail-service provider's proximity to that region.

14. The machine-readable of claim 8, wherein the method further comprises:
selecting the mail-service provider from a predefined list of mail-service providers before said transmitting the combined electronic order to a mail-service provided.

15. The machine-readable of claim 12, wherein the mail-service provider selection is based on a minimum order quantity as set by the mail-service provider.

16. The machine-readable of claim 12, wherein the mail-service provider selection is based on a per mail-piece price provided by the mail-service provider, a price in a pre-negotiated contract with the mail-service provider, or a published price as set by the mail-service provider.

17. The machine-readable of claim 10, wherein the method further comprises:
receiving a bill from the mail-service provider for printing and mailing of the specified mail-pieces to the specified destinations; and
sending a bill to each of the plurality of mail originators that reflects the bill for the mailing of each mail-piece that was mailed and was specified in the order received from that mail originator.

18. The machine-readable of claim 10, wherein the method further comprises:
archiving the mail-pieces that were transmitted to the mail-service provider;
receiving a request from a mail originator for mail-pieces that were to be mailed based on an order from that mail originator; and
transmitting the requesting mail-pieces from the archives to the requesting mail originator.
